(19) United States
(12) Patent Application Publication
(10) Pub. No.: US 2018/0203269 A1
(43) Pub. Date: Jul. 19, 2018

(54) DISPLAY DEVICE AND ELECTRONIC SHELF LABEL

(71) Applicant: Japan Display Inc., Tokyo (JP)

(72) Inventors: Masaya TAMAKI, Tokyo (JP); Masashi MITSUI, Tokyo (JP)

(21) Appl. No.: 15/865,663

(22) Filed: Jan. 9, 2018

(30) Foreign Application Priority Data
Jan. 13, 2017 (JP) 2017-004300

(51) Int. Cl. G02F 1/1343; G02F 1/1333; G02F 1/1362; G02F 1/1335

(52) U.S. Cl. CPC G02F 1/1343; G02F 1/133345; G02F 1/133528; G02F 1/133514; G02F 1/136286

(57) ABSTRACT

According to an aspect, a display device includes: a first substrate; a second substrate facing the first substrate; a liquid crystal layer provided between the first substrate and the second substrate; and a reflective electrode provided between the first substrate and the liquid crystal layer. The reflective electrode includes a plurality of raised portions that reflect incident light entering from outside. When the reflective electrode is divided into a plurality of micro regions each having a certain area in planar view, a rate of inclination angles of the raised portions is a value obtained by dividing the number of the micro regions having the inclination angles within a certain angle range, by the total number of the micro regions. The inclination angles of the raised portions are distributed such that the rate of the inclination angles of 17° or larger is 0.25 or higher.

### CROSS-REFERENCE TO RELATED APPLICATIONS

This application claims priority from Japanese Application No. 2017-004300, filed on Jan. 13, 2017, the contents of which are incorporated by reference herein in its entirety.

### BACKGROUND

### 1. Technical Field

The present disclosure relates to a display device and an electronic shelf label.

### 2. Description of the Related Art

Examples of display devices include, other than a transmissive display device that performs display by using transmitted light of a backlight on the back side of a screen, a reflective liquid-crystal display device that performs display by using reflected light obtained by reflecting the light that has entered from the outside. Japanese Patent Application Laid-open Publication No. H11-326615 (JP-A-H11-326615), for example, discloses a reflective liquid-crystal display device including a reflecting plate for reflecting the light from the outside. In JP-A-H11-326615, an inclination angle of the reflecting plate is set so as to obtain uniform reflected light in a certain range in a regular reflection direction.

In JP-A-H11-326615, an incident angle of incident light and an output angle of reflected light reflected by the reflecting plate are in opposite directions with respect to the normal line direction of a display surface. For example, a display device may be used as an electronic shelf label. In this case, the display device is placed such that the display surface thereof is vertical to the floor surface under an environment in which a lighting apparatus is fixed on the ceiling. When an observer sees the display surface of such a display device obliquely from above, the observer may have a difficulty to visually recognize an image on the display surface.

### SUMMARY

According to an aspect of the present disclosure, a display device includes: a first substrate; a second substrate facing the first substrate; a liquid crystal layer provided between the first substrate and the second substrate; and a reflective electrode provided between the first substrate and the liquid crystal layer. The reflective electrode includes a plurality of raised portions that reflect incident light entering from outside. When the reflective electrode is divided into a plurality of micro regions each having a certain area in planar view, a rate of inclination angles of the raised portions is a value obtained by dividing the number of the micro regions having the inclination angles within a certain angle range, by the total number of the micro regions. The inclination angles of the raised portions are distributed such that the rate of the inclination angles of 17° or larger is 0.25 or higher.

According to another aspect of the present disclosure, an electronic shelf label includes: the display device; and a housing that houses the display device. The housing is provided with a mark indicating a predetermined incident direction of light.

### BRIEF DESCRIPTION OF THE DRAWINGS

FIG. 1 is a cross-sectional view illustrating a configuration example of a display device according to an embodiment;

FIG. 2 is a schematic circuit diagram illustrating a basic pixel circuit according to the embodiment;

FIG. 3 is a plan view of reflective electrodes according to the embodiment;

FIG. 4 is a cross-sectional view taken along the line IV-IV′ in FIG. 3;

FIG. 5 is a block diagram illustrating one example of a circuit configuration of a sub pixel employing an MIP technology;

FIG. 6 is a timing chart for explaining the operation of the sub pixel employing the MIP technology;

FIG. 7 is a plan view of the reflective electrode;

FIG. 8 is a cross-sectional view taken along the line VIII-VIII′ in FIG. 7;

FIG. 9 is an explanatory diagram for explaining one example of installation positions of the display devices according to the embodiment and a viewpoint position of an observer;

FIG. 10 is a graph illustrating a relation among an installation height of the display device, a viewpoint angle of the observer, an output angle of light, and an inclination angle of a panel;

FIG. 11 is an explanatory diagram for explaining a relation between an incident angle of light and an output angle of the light according to a display device of a comparative example;

FIG. 12 is a graph illustrating a relation between an incident angle of light and an output angle of the light according to the display device of the comparative example;

FIG. 13 is an explanatory diagram for explaining one example of a relation between an incident angle of light and an output angle of the light according to the display device of the embodiment;

FIG. 14 is an explanatory diagram for explaining another example of a relation between an incident angle of light and an output angle of the light according to the display device of the embodiment;

FIG. 15 is a graph illustrating a relation between an inclination angle of the reflective electrode and an incident angle of light;

FIG. 16 is a graph illustrating a relation between a height of the reflective electrode and an inclination angle of the reflective electrode;

FIG. 17 is an explanatory diagram for explaining a relation between an inclination angle of the reflective electrode and an output angle of light;

FIG. 18 is a graph illustrating a relation between an inclination angle of the reflective electrode and a rate of the inclination angle of the reflective electrode;

FIG. 19 is a graph illustrating a relation between exposure time and the reflectivity of light;

FIG. 20 is a graph illustrating a relation between an inclination angle and a rate of a cumulative amount of inclination angles;

FIG. 21 is a table illustrating a relation between an azimuth angle range and a rate of an inclination angle;

FIG. 22 is a graph illustrating reflectivity rates of light on the reflective electrodes having different azimuth angle ranges;

FIG. 23 is a plan view for explaining an azimuth angle of the reflective electrode;

FIG. 24 is a schematic diagram illustrating shape data of the reflective electrode for explaining one example of a measurement method of inclination angle distribution;

FIG. 25 is a schematic diagram illustrating a state in which the shape data of the reflective electrode is divided for explaining one example of a measurement method of inclination angle distribution;

FIG. 26 is a plan view for explaining micro regions of the reflective electrode;

FIG. 27 is a schematic diagram illustrating a normal vector of a micro region of the reflective electrode;

FIG. 28 is a cross-sectional view illustrating a reflective electrode according to a modification of the embodiment;

FIG. 29 is a process diagram for explaining one example of a manufacturing method of the reflective electrode according to the embodiment; and

FIG. 30 is a diagram illustrating a configuration example of an electronic shelf label according to the embodiment.

### DETAILED DESCRIPTION

Modes (embodiments) for carrying out the present disclosure will be described below in detail with reference to the drawings. The contents described in the embodiments are not intended to limit the present disclosure. Components described below include components easily conceivable by those skilled in the art and components substantially identical therewith. Furthermore, the components described below can be appropriately combined. The disclosure is given by way of example only, and various changes made without departing from the spirit of the disclosure and easily conceivable by those skilled in the art naturally fall within the scope of the present disclosure. The drawings may possibly illustrate the width, the thickness, the shape, and other elements of each unit more schematically than the actual aspect to simplify the explanation. These elements, however, are given by way of example only and are not intended to limit interpretation of the present disclosure. In the specification and the drawings, components similar to those previously described with reference to a preceding drawing are denoted by like reference numerals, and overlapping explanation thereof will be appropriately omitted. In this disclosure, when an element is described as being “on” another element, the element can be directly on the other element, or there can be one or more elements between the element and the other element.

Display Device

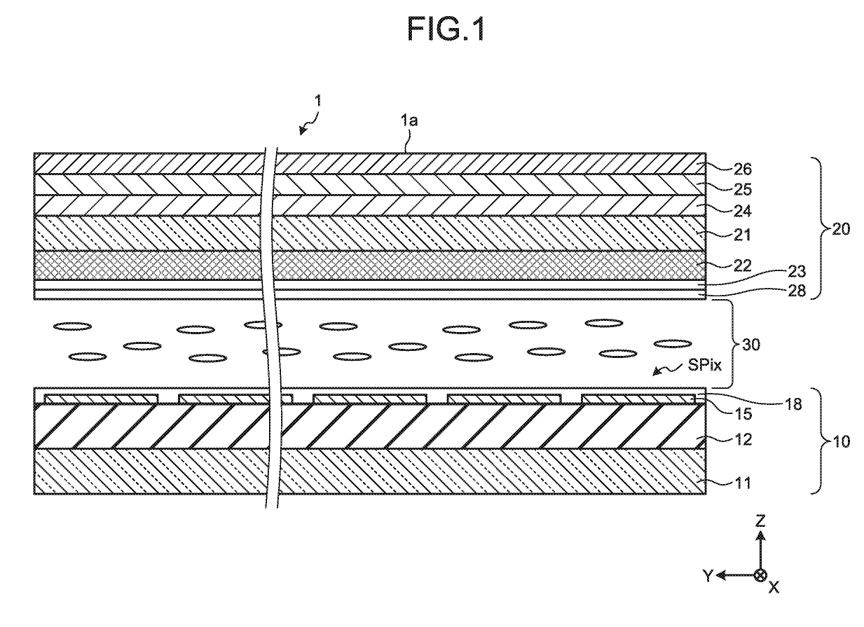

FIG. 1 is a cross-sectional view illustrating a configuration example of a display device according to an embodiment. As illustrated in FIG. 1, a display device 1 includes a first panel 10, a second panel 20, and a liquid crystal layer 30. The second panel 20 is arranged to face the first panel 10. The liquid crystal layer 30 is provided between the first panel 10 and the second panel 20. A surface of the second panel 20 is a display surface 1a for displaying an image. The light that has entered from the outside on the display surface 1a side is reflected by reflective electrodes 15 of the first panel 10 and is emitted from the display surface 1a. The display device 1 of the present embodiment is a reflective liquid-crystal display device that displays an image on the display surface 1a by using this reflected light. In this specification, it is assumed that a direction in parallel with the display surface 1a is an X direction and a direction intersecting with the X direction on a plane in parallel with the display surface 1a is a Y direction. It is further assumed that a direction perpendicular to the display surface 1a is a Z direction.

The first panel 10 includes a first substrate 11, an insulating layer 12, the reflective electrodes 15, and an orientation film 18. A glass substrate or a resin substrate is employed for the first substrate 11, for example. Circuit elements and various wiring such as gate lines GCL and data lines SGL, which are not illustrated, are provided on the surface of the first substrate 11. Examples of the circuit elements include a switching element such as a thin film transistor (TFT), and a capacitive element.

The insulating layer 12 is provided on the first substrate 11 and flattens the surface of the circuit elements and the various wiring as a whole. The reflective electrodes 15 are provided on the insulating layer 12. The orientation film 18 is provided between the reflective electrodes 15 and the liquid crystal layer 30. The reflective electrodes 15 are formed of a metal such as aluminum (Al) and silver (Ag), for example. The reflective electrodes 15 may be configured such that those metal materials and a translucent conductive material such as indium tin oxide (ITO) are stacked in layers. The reflective electrodes 15, which employ a material with excellent reflectivity, serve as a reflecting plate that diffusely reflects the light that has entered from the outside.

The light reflected by the reflective electrodes 15 is partly scattered by the diffuse reflection, but most of the light travels toward the display surface 1a side in a uniform direction. The reflective electrodes 15 are provided corresponding to respective sub pixels SPix and, a transmissive state of the light in the liquid crystal layer 30 is adjusted for each sub pixel SPix in accordance with a change in level of a voltage applied to the reflective electrode 15. That is, the reflective electrode 15 further functions as a pixel electrode. In FIG. 1, the reflective electrodes 15 and the insulating layer 12 are illustrated to be flat, but the detailed configuration thereof will be described later.

The second panel 20 includes a second substrate 21, a color filter 22, a common electrode 23, an orientation film 28, a quarter-wave plate 24, a half-wave plate 25, and a polarizing plate 26. The color filter 22 and the common electrode 23 are provided on a surface facing the first panel 10, out of the surfaces of the second substrate 21. The orientation film 28 is provided between the common electrode 23 and the liquid crystal layer 30. The quarter-wave plate 24, the half-wave plate 25, and the polarizing plate 26 are sequentially stacked in layers on the surface on the display surface 1a side of the second substrate 21.

The second substrate 21 is a glass substrate or a resin substrate, for example. The common electrode 23 is formed of a translucent conductive material, for example, ITO. The common electrode 23 is arranged to face the reflective electrodes 15, and supplies a common potential for each of the sub pixels SPix. The color filter 22 has three filters of R (red), G (green), and B (blue), for example. The color filter 22 may include a W (white) filter, or may include filters of five or more different colors.

The liquid crystal layer 30 includes nematic liquid crystal, for example. The liquid crystal layer 30 modulates light transmitted through the liquid crystal layer 30 for each sub pixel SPix in accordance with a change in level of a voltage applied between the common electrode 23 and the reflective electrode 15.

The incident light that has entered from the display surface 1a side of the display device 1 is transmitted through the second panel 20 and the liquid crystal layer 30, and reaches the reflective electrodes 15. Then, the incident light is diffusely reflected by the reflective electrodes 15. The light diffusely reflected by the reflective electrode 15 is transmitted through the liquid crystal layer 30, is modulated for each of the sub pixels SPix, and is emitted from the display surface 1a. This allows an image to be displayed. In the present embodiment, the reflective electrodes 15 each have an uneven pattern to reflect the incident light in certain directions.

In this way, the display device 1 employs an inner surface diffusion method that performs diffuse reflection by the reflective electrodes 15. Thus, the second panel 20 does not necessarily include a light scattering member between the second substrate 21 and the polarizing plate 26. The display device 1 is a reflective display device that performs display by reflecting external light, and thus has no light source such as a front light and a backlight. However, the present disclosure is not limited thereto, and the display device 1 may include a light source such as a front light and a backlight. In this case, the front light is provided on the display surface 1a side of the second panel 20. The backlight is provided on the back surface of the first panel 10, that is, the opposite side of the liquid crystal layer 30 with respect to the first panel 10. When the backlight is employed, the light from the backlight passes between the reflective electrodes 15 and then reaches the display surface 1a. Such light functions as auxiliary light.

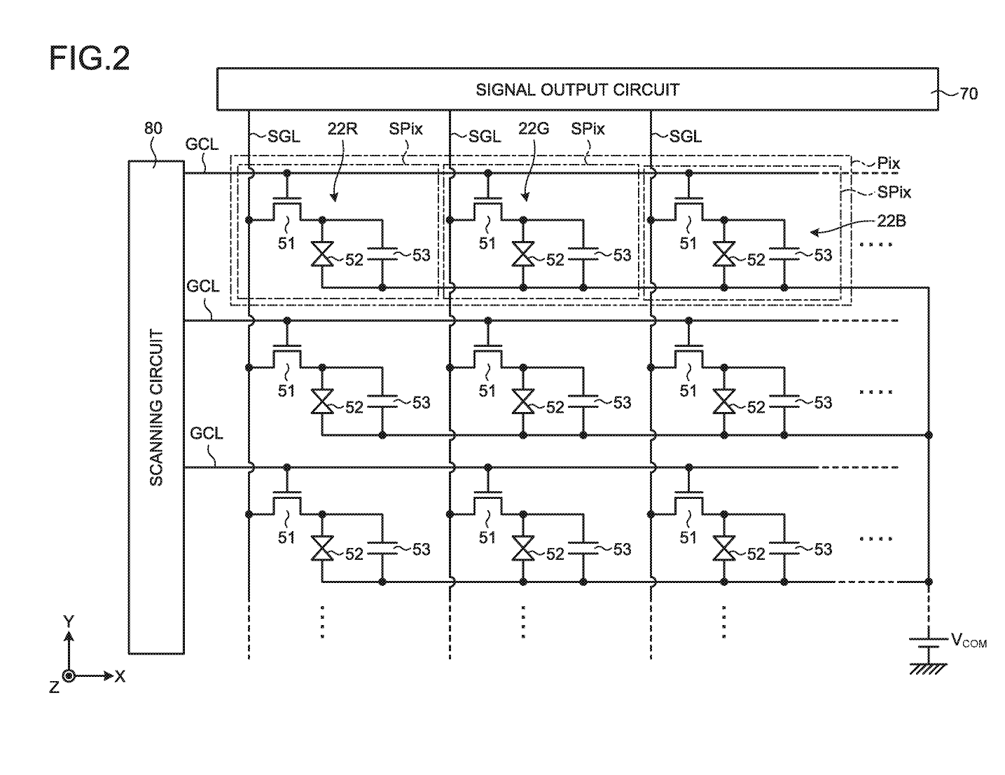

FIG. 2 is a schematic circuit diagram illustrating a basic pixel circuit according to the embodiment. Switching elements 51 of the respective sub pixels SPix and wiring such as data lines SGL and gate lines GCL are formed on the first substrate 11 illustrated in FIG. 1. The data line SGL is wiring that supplies a pixel signal to each reflective electrode 15. The gate line GCL is wiring that supplies a drive signal that drives each switching element 51. The data lines SGL and the gate lines GCL extend on a plane in parallel with the surface of the first substrate 11.

As illustrated in FIG. 2, the display device 1 has the sub pixels SPix arrayed in a matrix form. The sub pixels SPix each include the switching element 51, a liquid crystal element 52, and a holding capacitor 53. The switching element 51 is constituted by a thin-film transistor, and in this example, by an n-channel metal oxide semiconductor (MOS) TFT. The liquid crystal element 52 includes a liquid crystal capacitor that is formed between the reflective electrode 15 and the common electrode 23. The holding capacitor 53 may include a capacitive element, or may employ a capacitor formed between the electrodes.

The gate lines GCL are coupled to a scanning circuit 80. The scanning circuit 80 sequentially scans the gate lines GCL to drive them. The scanning circuit 80 applies a scan signal V_{scan} to the gate of the switching element 51 via the gate line GCL. Accordingly, the scanning circuit 80 sequentially selects one line (one horizontal line) out of the sub pixels SPix. The data lines SGL are coupled to a signal output circuit 70. The signal output circuit 70 supplies the pixel signal to the sub pixels SPix constituting the selected one horizontal line via the data line SGL. In these sub pixels SPix, display is performed on a horizontal line-by-horizontal line basis in accordance with the supplied pixel signal. In performing this display operation, a common potential V_{COM} is applied to the common electrode 23.

Three color regions 22R, 22G, and 22B corresponding to the respective three colors of R, G, and B of the color filter 22 are associated with the respective sub pixels SPix illustrated in FIG. 2. The sub pixels SPix corresponding to the three color regions 22R, 22G, and 22B constitute a pixel Pix as one set. This allows the display device 1 to perform color display.

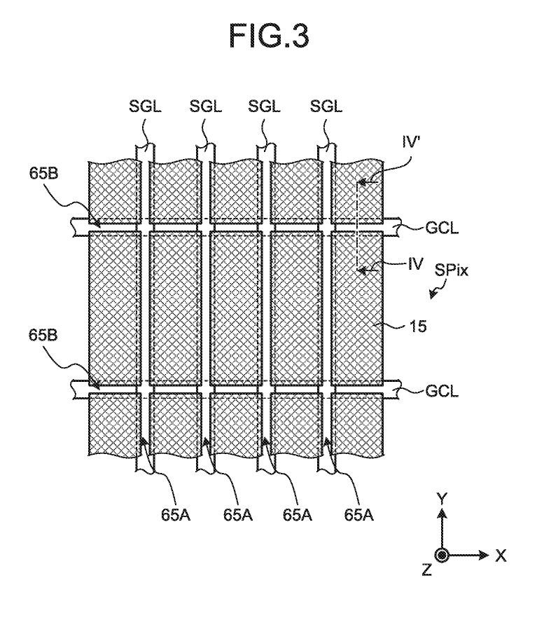

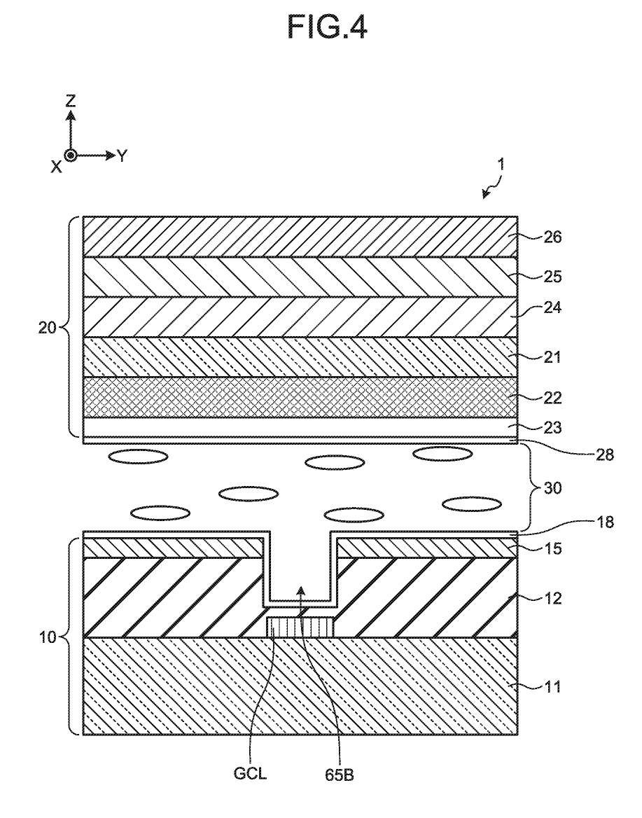

FIG. 3 is a plan view of the reflective electrodes according to the embodiment. FIG. 4 is a cross-sectional view taken along the line IV-IV′ in FIG. 3. In FIG. 3, the reflective electrodes 15 are illustrated by hatching. FIG. 4 illustrates a cross section structure of two adjacent sub pixels SPix.

As illustrated in FIG. 3, the reflective electrode 15 has a rectangular shape having short sides along the X direction and long sides along the Y direction, in a planar view. The reflective electrodes 15 are arrayed in a matrix form so as to correspond to the respective sub pixels SPix (see FIG. 2). The shape of the reflective electrode 15 is not limited to the rectangular shape, and may be other shapes such as a square shape, an elliptical shape, an oval shape, and an irregular shape. A space 65A is provided between the reflective electrodes 15 arrayed in the X direction. A space 65B is provided between the reflective electrodes 15 arrayed in the Y direction. The data line SGL is provided along the space 65A in planar view. The gate line GCL intersects with the data line SGL and is provided along the space 65B, in planar view.

As illustrated in FIG. 4, the gate line GCL is provided between the reflective electrodes 15 and the first substrate 11 in a direction perpendicular to the first substrate 11. The gate line GCL is provided to face the space 65B in a direction in parallel with the plane of the first substrate 11. Similarly, the data line SGL is provided in the space 65A as illustrated in FIG. 3. The present disclosure can also employ a configuration in which the gate lines GCL and the data lines SGL extend directly underneath the reflective electrodes 15.

As illustrated in FIG. 4, the common electrode 23 of the second panel 20 is continuously provided to face the reflective electrodes 15 and the spaces 65B. The common electrode 23 may be a single continuous electrode or may be divided into a plurality of electrodes.

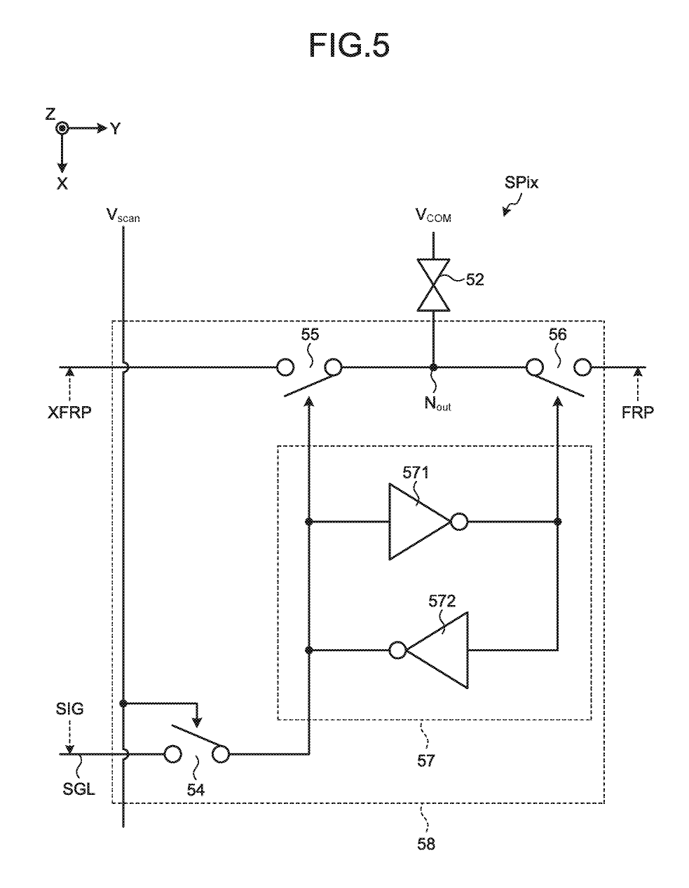

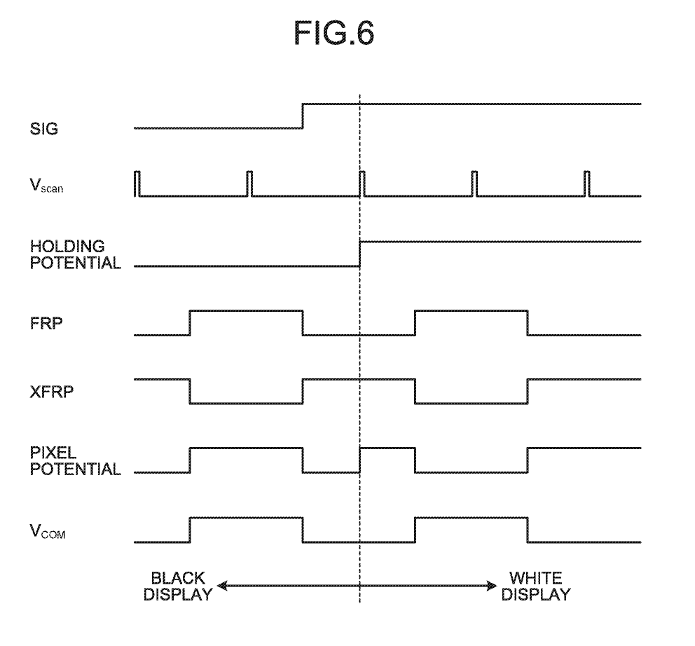

FIG. 5 is a block diagram illustrating one example of a circuit configuration of a sub pixel employing a memory-in-pixel (MIP) technology. FIG. 6 is a timing chart for explaining the operation of the sub pixel employing the MIP technology. The display device 1 of the present embodiment may employ the MIP technology. In the MIP technology, each sub pixel SPix has a memory function to store data.

As illustrated in FIG. 5, the sub pixel SPix includes a drive circuit 58 in addition to the liquid crystal element 52. The drive circuit 58 includes three switches 54, 55, and 56 and a latch 57, and has a static random access memory (SRAM) function.

The switch 54 is coupled to the data line SGL. The switch 54 is turned on in response to reception of the scan signal V_{scan} supplied from the scanning circuit 80 (see FIG. 2). Data SIG is supplied from the signal output circuit 70 (see FIG. 2) to the latch 57 via the data line SGL and the switch 54. The latch 57 includes inverters 571 and 572 coupled in parallel in mutually opposite directions, and holds (latches) an electrical potential according to the data SIG.

A control pulse XFRP having a phase opposite to that of the common potential V_{COM} is applied to one of the terminals of the switch 55. A control pulse FRP having the same phase as that of the common potential V_{COM} is applied to one of the terminals of the switch 56. The others of the terminals of the respective switches 55 and 56 are coupled to a common connection node, which is an output node Nₒᵤₜ of the pixel circuit. Either one of the switches 55 and 56 is turned on according to a polarity of the holding potential of the latch 57. Accordingly, the control pulse FRP or the control pulse XFRP is applied to the reflective electrode 15.

As illustrated in FIG. 6, when the holding potential of the latch 57 has a negative polarity, a pixel potential of the liquid crystal element 52 has the same phase as that of the common potential V_{COM} so that black is displayed. When the holding potential of the latch 57 has a positive polarity, the pixel potential of the liquid crystal element 52 has the phase opposite to that of the common potential V_{COM} so that white is displayed.

In this way, in the sub pixel SPix of an MIP, either one of the switches 55 and 56 is turned on according to the holding potential of the latch 57. Accordingly, the control pulse FRP or the control pulse XFRP is applied to the reflective electrode 15 of the liquid crystal element 52. As a result, a constant voltage is consistently applied to the sub pixel SPix, thereby preventing the occurrence of shading.

The MIP technology can realize display in an analog display mode and display in a memory display mode by having a memory to store data in the pixel. The analog display mode is a display mode to display a gradation of pixels in an analog manner, in accordance with the above-described pixel signal. The memory display mode is a display mode to display a gradation of pixels in a digital manner, based on information stored in the memory in the pixel.

In the memory display mode, the information stored in the memory is used, which does not require performing a write operation for a signal potential in a frame period. Thus, in the memory display mode, power consumption is lower than that in the analog display mode, thereby allowing the display device 1 to reduce its power consumption.

The above description has been made using the example where the sub pixel SPix includes the SRAM built therein. Alternatively, the sub pixel SPix may include a dynamic random access memory (DRAM) built therein. A pixel that includes known memory liquid crystal may be employed for the pixel having the memory function, other than the above-described MIP.

The display mode of liquid crystal includes a normally-white mode and a normally-black mode. The normally-white mode is a mode to display white when no electric field is generated (no voltage is applied), and display black when an electric field is generated. The normally-black mode is a mode to display black when no electric field is generated, and display white when an electric field is generated. In both the modes, the liquid crystal cell has the same configuration, but the polarizing plate 26 in FIG. 1 is arranged in a different manner. The display device 1 of the present embodiment is driven in the normally-black mode to display black when no electric field is generated (no voltage is applied), and display white when an electric field is generated.

Reflective Electrode

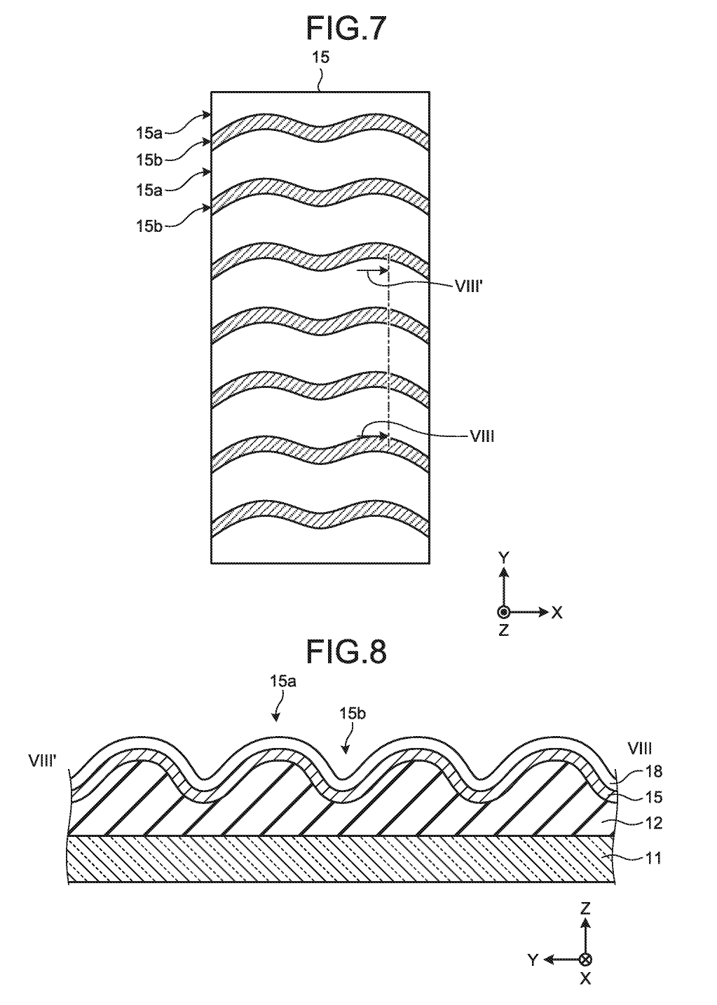

The following describes the detailed configuration of the reflective electrode 15 according to the present embodiment. FIG. 7 is a plan view of the reflective electrode. FIG. 8 is a cross-sectional view taken along the line VIII-VIII′ in FIG. 7. As illustrated in FIG. 7, the reflective electrode 15 includes raised portions 15a and recessed portions 15b. The raised portion 15a is provided along the X direction, and a plurality of the raised portions 15a are arranged in the Y direction. Accordingly, the recessed portion 15b is formed between the raised portions 15a in juxtaposition in the Y direction. In other words, the raised portion 15a and the recessed portion 15b are alternately and repeatedly provided in the Y direction. The raised portion 15a and the recessed portion 15b constitute a wave line shape formed by repeatedly arraying a circular arc or an elliptic arc in the X direction, in planar view. In the present embodiment, as illustrated in FIG. 8, the curvature of the raised portion 15a in a cross section is smaller than the curvature of the recessed portion 15b. As a result, as illustrated in FIG. 7, the area ratio of the raised portion 15a is larger than that of the recessed portion 15b, in planar view. Alternatively, the width (distance between the upper and lower end portions) of the raised portion 15a is larger than the width of the recessed portion 15b, in planar view.

As illustrated in FIG. 8, the insulating layer 12 formed on the first substrate 11 has a fine uneven surface. The reflective electrode 15 is provided along the surface of the insulating layer 12 so that the raised portions 15a and the recessed portions 15b are formed. The orientation film 18 is also provided along the reflective electrode 15 and has an uneven shape. In the present embodiment, a direction of output light reflected by the reflective electrode 15 can be appropriately set in accordance with an inclination angle of the raised portion.

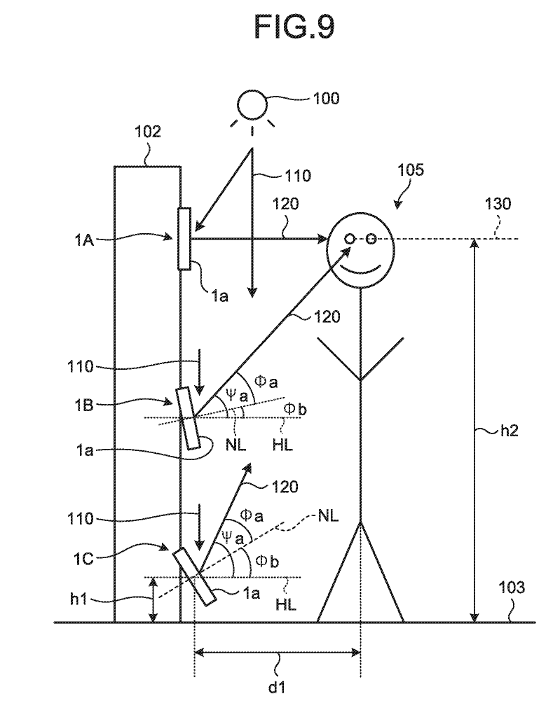

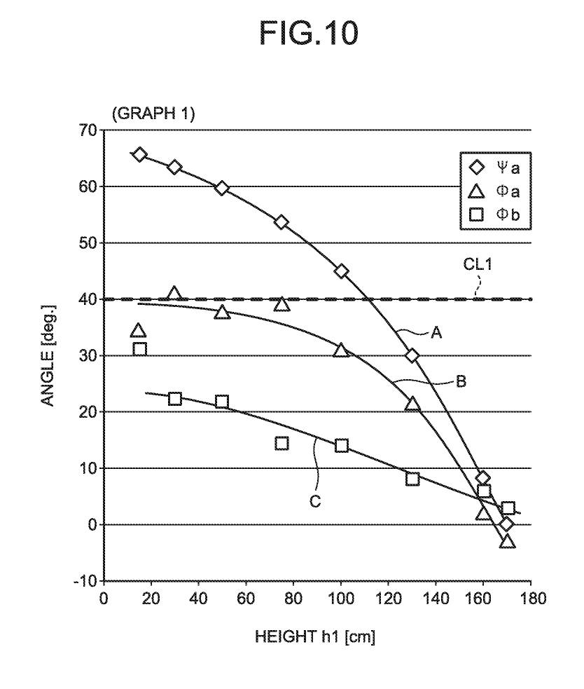

FIG. 9 is an explanatory diagram for explaining one example of installation positions of the display devices according to the embodiment and a viewpoint position of an observer. FIG. 10 is a graph illustrating a relation among an installation height of the display device, a viewpoint angle of the observer, an output angle of light, and an inclination angle of a panel.

As illustrated in FIG. 9, display devices 1A, 1B, and 1C are each mounted on a shelf 102.

The display devices 1A, 1B, and 1C each have the same configuration as that of the above-described display device 1. The display devices 1A, 1B, and 1C differ from one another in height h1 from a floor surface 103, and differ from one another in panel inclination angle Φb. The panel inclination angle Φb is an angle formed by a normal line NL of the display surface 1a and a horizontal direction HL. As illustrated in a curve C of the graph 1 in FIG. 10, as the height h1 from the floor surface becomes smaller, the panel inclination angle Φb increases. Accordingly, it becomes easier for an observer 105 to visually recognize the image displayed on the display surface 1a.

The display device 1A is installed at substantially the same height h2 as that of a viewpoint position 130 of the observer 105, and output light 120 is emitted in a direction in parallel with the normal line NL. The height h1 of each of the display devices 1B and 1C from the floor surface is smaller than the height h2 of the display device 1A. A distance d1 in the horizontal direction HL between the observer 105 and each of the display devices 1B and 1C is in an approximate range from several tens of centimeters to one meter, for example. Thus, the observer 105 may look into the display devices 1B and 1C obliquely from above. In this case, incident light 110 from a lighting fixture 100 serving as a light source is incident on the floor surface 103 in a substantially perpendicular direction. The output light 120 from the display devices 1B and 1C is required to travel toward the same side as the incident direction of the incident light 110, with respect to the normal line NL, so that the observer 105 can visually recognize the image well on the display surface 1a.

It is assumed that an angle formed by the normal line NL and the output light 120 is an output angle Φa, and an angle formed by the horizontal direction HL and the output light 120 is an angle Ψa. As illustrated in FIG. 10, the output angle Φa and the angle Ψa increase as the height h1 from the floor surface becomes smaller. As illustrated by a broken line CL1 in FIG. 10, the maximum value of the output angle Φa is approximately 40°. As illustrated in FIGS. 9 and 10, in order for the observer 105 to visually recognize the image well on the display surface 1a, it is preferable that the output light 120 be emitted toward the same side as the incident light 110 with respect to the normal line NL, at the output angle Φa ranging from 0° to 40°.

As illustrated in FIG. 10, the panel inclination angle Φb is approximately 30° at the maximum. That is, the angle formed by the incident light 110 and the normal line NL is 60° (=90°−Φb). In the display devices 1B and 1C illustrated in FIG. 9, when the incident light 110 enters from the perpendicular direction, it is preferable that the incident light 110 at the incident angle ranging from 0° to 60° with respect to the normal line NL can be reflected toward the same side as the incident light 110 with respect to the normal line NL.

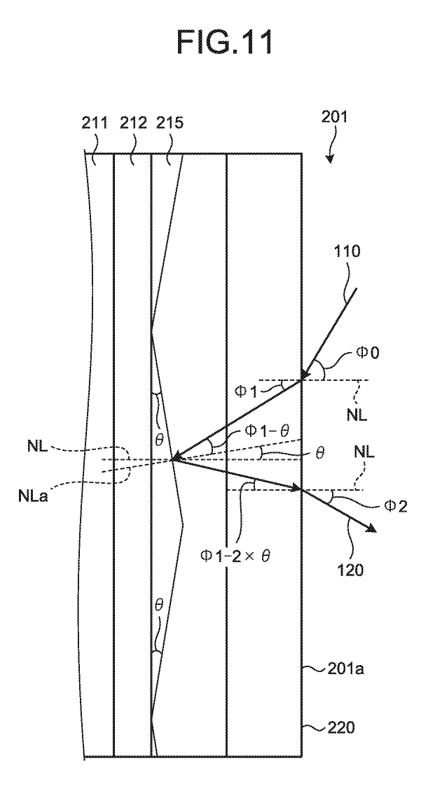

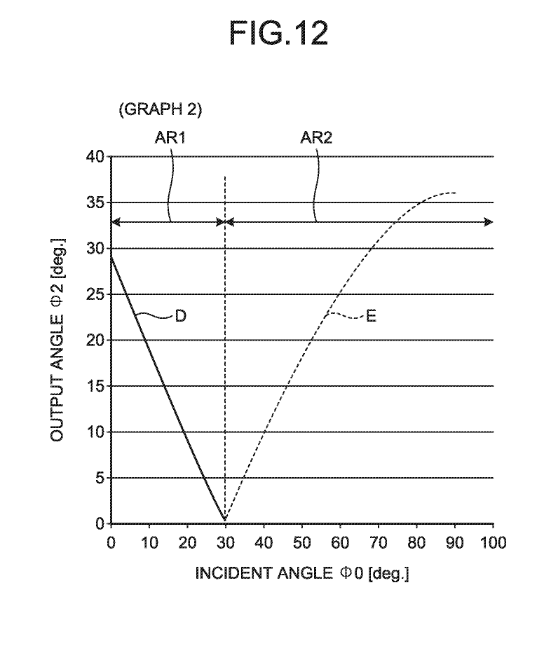

FIG. 11 is an explanatory diagram for explaining a relation between an incident angle of light and an output angle of the light according to a display device of a comparative example. FIG. 12 is a graph illustrating a relation between an incident angle of light and an output angle of the light according to the display device of the comparative example. A display device 201 of the comparative example illustrated in FIG. 11 has the same configuration as that of the above-described display device 1. In the display device 201 of the comparative example, an inclination angle θ of a reflective electrode 215 is set to θ=9°, for example. In the reflective electrode 215, the inclination angle actually changes according to a position as illustrated in FIG. 8. However, FIG. 11 illustrates the reflective electrode 215 in a triangle shape in cross-sectional view for easier explanation. An insulating layer 212 provided on a first substrate 211 has an uneven shape corresponding to the shape of the reflective electrode 215 as illustrated in FIG. 8, but FIG. 11 schematically illustrates the insulting layer 212 to be flat.

As illustrated in FIG. 11, it is assumed that an angle formed by the incident direction of the incident light 110 and the normal line NL is an incident angle Φ0, and an angle formed by the output direction of the output light 120 and the normal line NL is an output angle Φ2. The incident light 110 travels at a first angle Φ1 formed with the normal line NL according to the Snell's law indicated in Expression (1). In Expression (1), n₀ is a refractive index at the outside (in air) of a display surface 201a of the display device 201, and it is expressed as n₀=1. Furthermore, n₁ is a refractive index between the display surface 201a of the display device 201 and the reflective electrode 215. In this case, n₁ can be assumed to be substantially the same value as a refractive index of a glass substrate included in a second panel 220, and it is expressed as n₁=1.55.

n₀×sin Φ0=n₁'sin Φ1 (1)

The incident light 110 traveling the inside of the display device 201 is reflected by the reflective electrode 215. In this case, the angle formed by a normal line NLa of the reflective electrode 215 and the incident light 110 is expressed as Φ1−θ. The incident light 110 is regularly reflected by the surface of the reflective electrode 215, and is reflected at an angle (Φ1−θ) toward the opposite side of the incident light 110 with respect to the normal line NLa. Then, the output light 120 is incident on the display surface 201a at an angle (Φ1−2×θ) with respect to the normal line NL of the display surface 201a. The output light 120 is emitted from the display surface 201a at the output angle Φ2 toward the opposite side of the incident light 110 with respect to the normal line NL according to the Snell's law indicated in Expression (1).

As illustrated in the graph 2 of FIG. 12, the output angle Φ2 changes according to the incident angle Φ0. In FIG. 12, the output angle of the output light 120 reflected toward the same side as the incident light 110 with respect to the normal line NL is indicated by a solid line D. Furthermore, the output angle of the output light 120 reflected toward the opposite side of the incident light 110 is indicated by a dotted line E. As illustrated in FIG. 12, the output light 120 is reflected toward the same side as the incident light 110 in an angle range AR1 in which the incident angle Φ0 ranges from 0° to 30°. Meanwhile, the output light 120 is reflected toward the opposite side of the incident light 110 in an angle range AR2 in which the incident angle Φ0 is larger than 30°.

In other words, in the display device 201 of the comparative example having the reflective electrode 215 with a small inclination angle θ, the output light 120 is reflected toward the same side as the incident light 110 only when the incident angle Φ0 ranges from 0° to 30°. Thus, as illustrated in FIG. 9, when the observer 105 looks into the display devices 1B and 1C obliquely from above, the observer 105 may have a difficulty to visually recognize an image displayed on the display surface 201a.

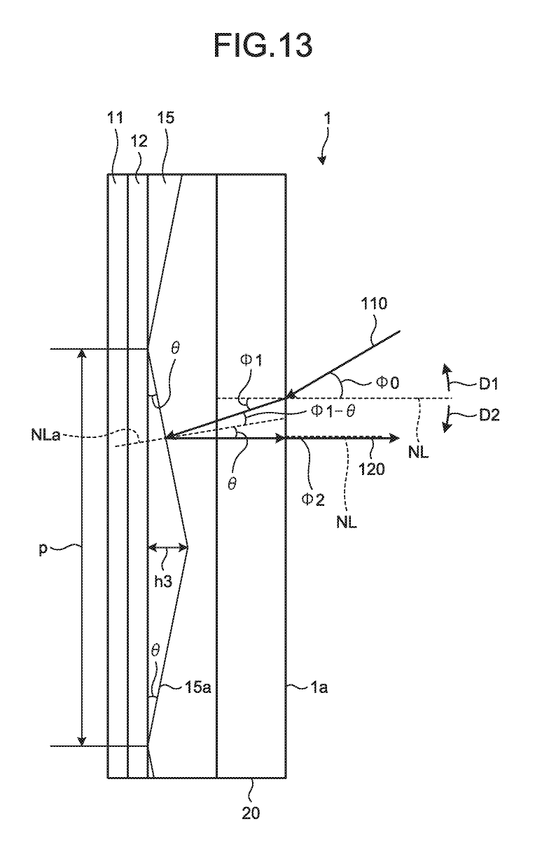

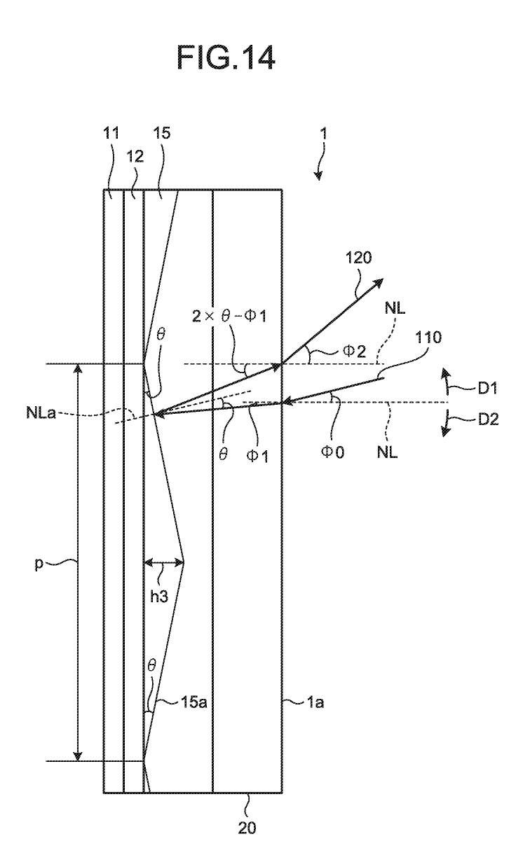

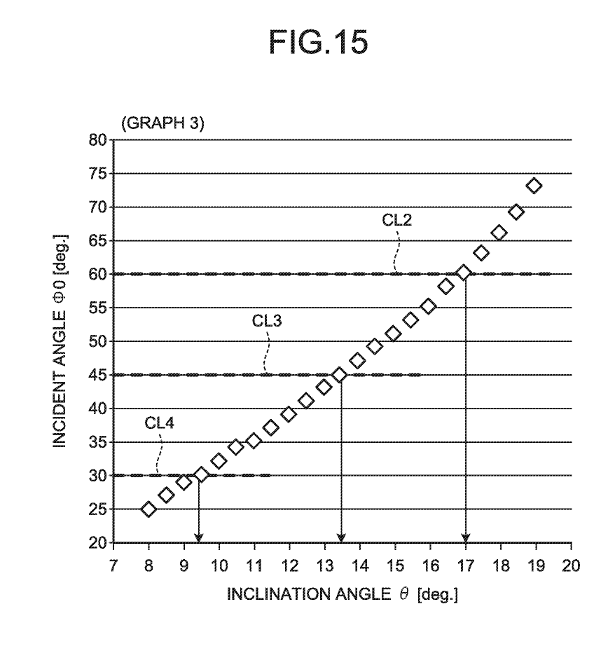

FIG. 13 is an explanatory diagram for explaining one example of a relation between an incident angle of light and an output angle of the light according to the display device of the embodiment. FIG. 14 is an explanatory diagram for explaining another example of a relation between an incident angle of light and an output angle of the light according to the display device of the embodiment. FIG. 15 is a graph illustrating a relation between an inclination angle of the reflective electrode and an incident angle of light. FIGS. 13 and 14 each illustrate the reflective electrode 15 in a triangle shape in cross-sectional view for easier explanation.

As illustrated in FIGS. 13 and 14, it is assumed that an angle formed by the surface of the raised portion 15a of the reflective electrode 15 and a plane in parallel with the first substrate 11 is an inclination angle θ. As illustrated in FIGS. 13 and 14, a height h3 of the reflective electrode 15 is a distance between the highest portion and the lowest portion of the reflective electrode 15, in the direction perpendicular to the plane of the first substrate 11. A pitch p of the reflective electrode 15 is a pitch at which the raised portion 15a are repeatedly arrayed, and in FIGS. 13 and 14, the pitch p indicates the width of a single raised portion 15a of the reflective electrode 15.

The example illustrated in FIG. 13 indicates a case where the output light 120 is emitted in the parallel direction to the normal line NL, that is, a case where the output angle Φ2 is 0°. It is assumed that, with respect to the normal line NL, a direction that is the same as the incident direction of the incident light 110 is a first direction D1, and an opposite direction of the incident direction of the incident light 110 is a second direction D2. In the example illustrated in FIG. 14, the incident angle Φ0 of the incident light 110 is smaller than that in FIG. 13. The output light 120 is emitted toward the first direction D1 side with respect to the normal line NL. The angle formed by the output light 120 and the normal line NL is the output angle Φ2.

In the display device 1 of the present embodiment, the incident light 110 enters at the incident angle Φ0 of 0° to 60° with respect to the normal line NL. The output light 120 is emitted toward the first direction D1 side (incident direction side) at the output angle Φ2 of 0° to 40° with respect to the normal line NL. Accordingly, as illustrated in FIG. 9, when the observer 105 looks into the display devices 1B and 1C obliquely from above, the observer 105 can visually recognize the image of the display surface 1a well.

The incident light 110 at a high incident angle Φ0 that is larger than 60° may cause higher reflectivity on the surface of the polarizing plate 26 (see FIG. 1). Thus, in the present embodiment, the explanation is made such that the incident angle Φ0 of 60° is assumed to be an upper limit.

The graph 3 in FIG. 15 indicates the relation between the inclination angle θ and the incident angle Φ0 when the output light 120 is emitted at the output angle Φ2 of 0°. That is, FIG. 15 indicates inclination angles θ at which the output light 120 can be emitted in the direction of the normal line NL according to different incident angles Φ0 of the incident light 110. As illustrated in FIG. 15, as the inclination angle θ increases, the incident angle Φ0 becomes larger. In other words, increasing the inclination angle θ expands the range of the incident angles Φ0 at which the output light 120 can be emitted to the first direction D1 side with respect to the normal line NL.

For example, as indicated by a broken line CL4, the reflective electrode 15 having the inclination angle θ of 9.4° can reflect the incident light 110 at the incident angle Φ0 of 0° to 30°, toward the first direction D1 side with respect to the normal line NL. As indicated by a broken line CL3, the reflective electrode 15 having the inclination angle θ of 13.5° can reflect the incident light 110 at the incident angle Φ0 of 0° to 45°, toward the first direction D1 side with respect to the normal line NL. As indicated by a broken line CL2, the reflective electrode 15 having the inclination angle θ of 17° can reflect the incident light 110 at the incident angle Φ0 of 0° to 60°, toward the first direction D1 side with respect to the normal line NL.

As a result, by making the inclination angle θ of the reflective electrode 15 17° or larger, the output light 120 is emitted toward the first direction D1 side at the output angle Φ2 of 0° or larger with respect to the normal line NL when the incident light 110 enters at the incident angle Φ0 of 0° to 60°.

Based on the above-described Expression (1), the inclination angle θ that satisfies a certain relation between the incident angle Φ0 and the output angle Φ2 can be obtained. For example, when the inclination angle θ is 20.5°, the incident light 110 enters at the incident angle Φ0 of 60° with respect to the normal line NL, and the output light 120 is emitted toward the first direction D1 side with respect to the normal line NL at the output angle Φ2 of 10°. Similarly, when the inclination angle θ is 23.5°, the incident light 110 enters at the incident angle Φ0 of 60°, and the output light 120 is emitted at the output angle Φ2 of 20°. When the inclination angle θ is 26.5°, the incident light 110 enters at the incident angle Φ0 of 60°, and the output light 120 is emitted at the output angle Φ2 of 30°. When the inclination angle θ is 29°, the incident light 110 enters at the incident angle Φ0 of 60°, and the output light 120 is emitted at the output angle Φ2 of 40°.

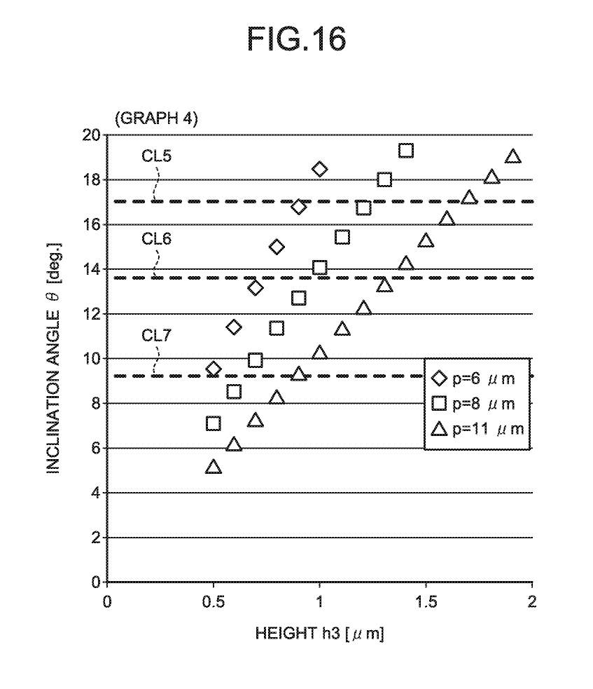

FIG. 16 is a graph illustrating a relation between a height of the reflective electrode and an inclination angle of the reflective electrode. FIG. 16 illustrates the relation between the height h3 of the reflective electrode 15 and the inclination angle θ when the pitch p of the reflective electrode 15 is changed to 6 μm, 8 μm, and 11 μm.

As illustrated in the graph 4 in FIG. 16, as the height h3 increases, the incident angle Φ0 becomes larger. When the height h3 is at a fixed value, the inclination angle θ becomes larger as the pitch p decreases. In the graph 4, a broken line CL5 indicates that the inclination angle θ is 17°, a broken line CL6 indicates that the inclination angle θ is 13.5°, and a broken line CL7 indicates that the inclination angle θ is 9.4°.

For example, as indicated by the broken line CL5, when the height h3 is approximately 0.9 μm and the pitch p is approximately 6 μm, the inclination angle θ is 17°. When the height h3 is approximately 1.2 μm and the pitch p is 8 μm, the inclination angle θ is 17°. Furthermore, when the height h3 is approximately 1.7 μm and the pitch p is 11 μm, the inclination angle θ is 17°. As indicated by the broken line CL6, when the height h3 is approximately 0.7 μm and the pitch p is approximately 6 μm, the inclination angle θ is 13.5°. As indicated by the broken line CL7, when the height h3 is approximately 0.5 μm and the pitch p is approximately 6 μm, the inclination angle θ is 9.4°.

The height h3 and the pitch p indicated in FIG. 16 are merely examples, and the configuration of the reflective electrode 15 is not limited thereto.

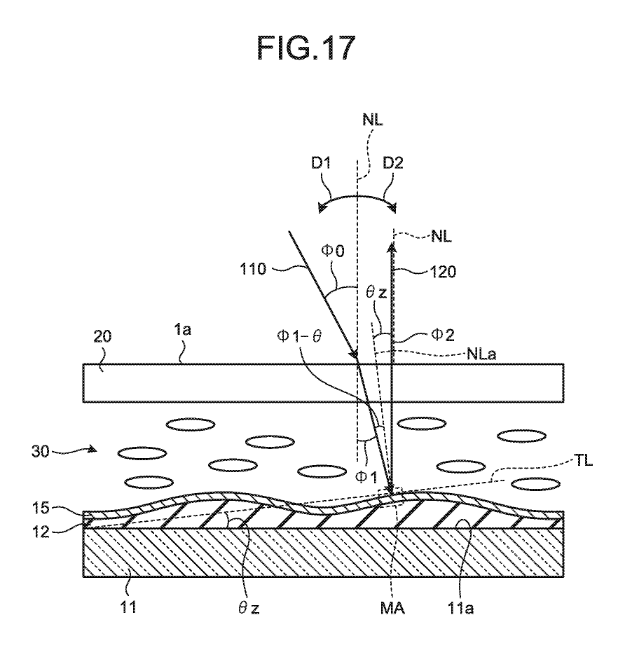

The following describes the distribution and the rate of the inclination angles θ of the reflective electrode 15. FIG. 17 is an explanatory diagram for explaining a relation between an inclination angle of the reflective electrode and an output angle of light. As illustrated in FIG. 17, the surface of the reflective electrode 15 has an uneven shape in which a pattern of a circular arc or an elliptic arc is repeated, in cross-sectional view. Thus, the reflective electrode 15 has distributed inclination angles θz and the inclination angle θz differs according to a position on the surface.

As illustrated in FIG. 17, in a micro region MA having a certain area of the reflective electrode 15, the inclination angle θz (first inclination angle) is an angle formed by a tangential line TL of the micro region MA and a surface 11a of the first substrate 11. That is, the inclination angle θz is equal to an angle (polar angle) formed by the normal line NLa of the micro region MA and the normal line NL of the display surface 1a. In the following description, the inclination angle θz may be expressed as the polar angle.

When the incident light 110 is incident on the micro region MA, the output light 120 is emitted at the output angle Φ2 in accordance with the inclination angle θz of the micro region MA. The example illustrated in FIG. 17 illustrates a case where the output angle Φ2 is 0°. When the position of the micro region MA is different, the inclination angle θz has a different value, and the output light 120 is emitted at a different output angle Φ2.

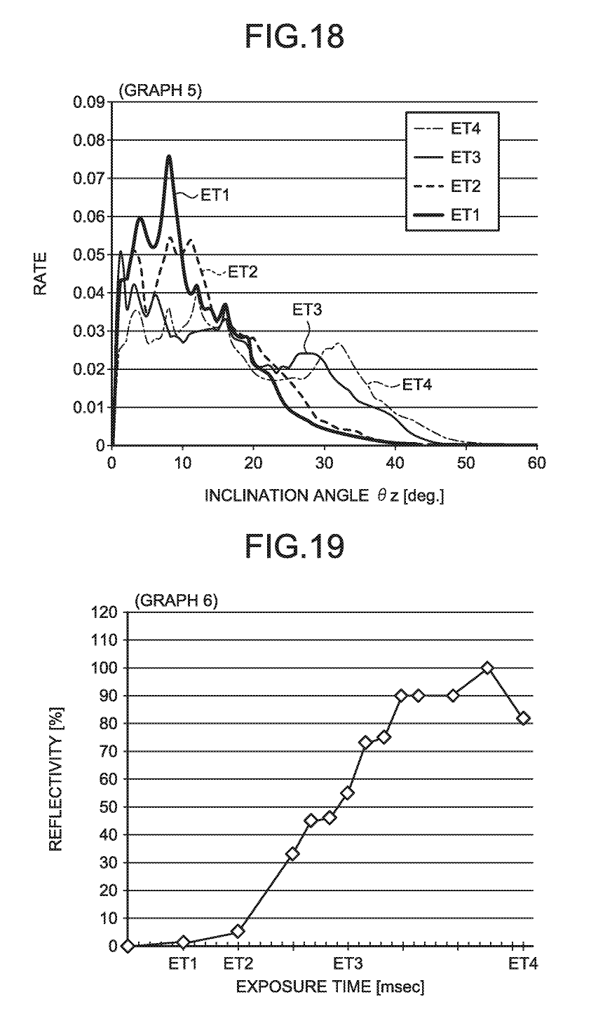

FIG. 18 is a graph illustrating a relation between an inclination angle of the reflective electrode and a rate of the inclination angle of the reflective electrode. FIG. 19 is a graph illustrating a relation between exposure time and the reflectivity of light. In the present specification, the “rate of the inclination angle θz” indicates, when a certain region of the reflective electrode 15 is divided in to a plurality of micro regions MA in planar view, an abundance ratio of the micro regions MA having the inclination angle θz. Specifically, the “rate of the inclination angle θz” is a value obtained by dividing the number of micro regions MA having the inclination angle θz within a certain angle range, by the total number of the micro regions MA. The graph 5 in FIG. 18 indicates the rate of the inclination angle θz for each 1°, and for each of different exposure time ET1, ET2, ET3, and ET4.

The exposure time ET1, ET2, ET3, and ET4 each indicates exposure time when forming the insulating layer 12 (see FIGS. 8 and 17) in the uneven shape by the photolithography method. The exposure time becomes longer in order of the exposure time ET1, ET2, ET3, and ET4. The longer the exposure time, the greater the height of the raised portion 15a of the reflective electrode 15 tends to become.

As illustrated in FIG. 18, at the exposure time ET1 and ET2, the rates of the inclination angles θz of approximately 15° or smaller are higher as compared with those at the exposure time ET3 and ET4. Meanwhile, at the exposure time ET3 and ET4, the rates of the inclination angles θz approximately 25° or larger are higher as compared with those at the exposure time ET1 and ET2. That is, the longer the exposure time, the higher the rate of large inclination angle θz tends to become.

The graph 6 in FIG. 19 indicates reflectivity in a case where the incident light 110 is incident at the incident angle Φ0 of 60° and the output light 120 is emitted toward the first direction D1 (incident direction) side with respect to the normal line NL at the output angle Φ2 of 40°. An optical property inspection apparatus LCD5200 (manufactured by Otsuka Electronics Co., Ltd.) was used to measure the reflectivity. As illustrated in FIG. 19, there is a tendency that the reflectivity at the incident angle Φ0 of 60° and the output angle Φ2 of 40° becomes higher at the exposure time ET2 or longer. That is, the distribution of the inclination angles θz at the exposure time ET2 or longer allows the component of the output light 120 emitted toward the first direction D1 side with respect to the normal line LN to increase when the incident light 110 is incident at the incident angle Φ0 of 60°. The height h3 of the raised portion 15a at the exposure time ET2 is approximately 1 μm, and the average of the pitches p of the raised portions 15a is approximately 11 μm, for example.

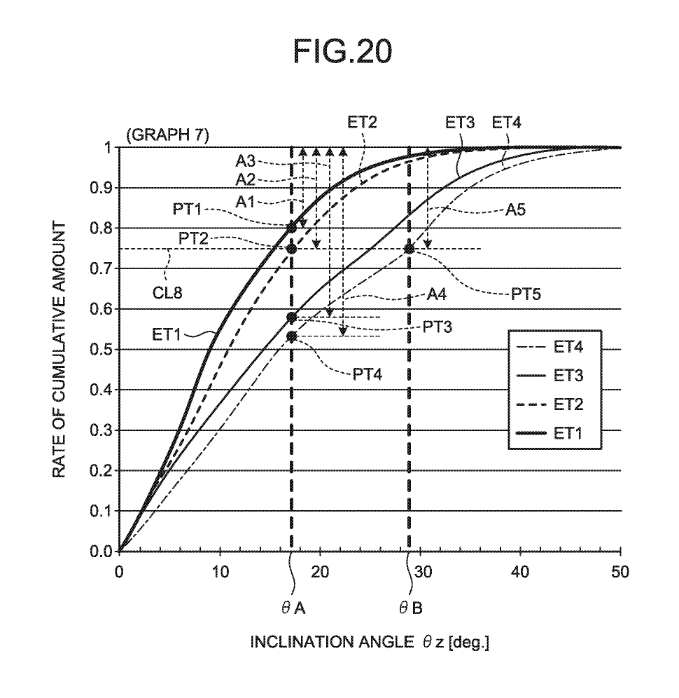

FIG. 20 is a graph illustrating a relation between an inclination angle and a rate of a cumulative amount of inclination angles. FIG. 18 indicates the rate of the inclination angle θz for each 1°, while the graph 7 in FIG. 20 indicates a cumulative amount of the inclination angles θz in FIG. 18. For example, when the inclination angle θz is θA=17° indicated by a broken line, each of the points PT1, PT2, PT3, and PT4 indicates a value obtained by dividing the number of micro regions MA included in a range of the inclination angle θz of 0° or larger and less than 17°, by the total number of the micro regions MA.

As illustrated in FIG. 20, the longer the exposure time, i.e., in order of the exposure time ET1, ET2, ET3, and ET4, a curve formed by the rates of the cumulative amounts becomes gentler. That is, the reflective electrodes 15 to be exposed for long exposure time, i.e., the exposure time ET3 and ET4, has the micro regions MA of the inclination angles θz widely ranging up to 30° or larger.

θA in FIG. 20 indicates that the inclination angle θz is θA=17°. That is, the inclination angle θA is the inclination angle θz at which the output light 120 is emitted at the output angle 12 of 0° when the incident light 110 enters at the incident angle Φ0 of 60°. θB indicates that the inclination angle θz is θB=29°. That is, the inclination angle θB is the inclination angle θz at which the output light 120 is emitted toward the first direction D1 side with respect to the normal line NL at the output angle Φ2 of 40° when the incident light 110 enters at the incident angle Φ0 of 60°.

When the inclination angle θz is θA (17°), the rate of the cumulative amount at the exposure time ET1 is approximately 0.8 as indicated at the point PT1. That is, the rate of the cumulative amount of the inclination angles θz that are 0° or larger and smaller than 17° is 0.8. The rate of the cumulative amount at the exposure time ET2 is 0.75 as indicated at the point PT2. The rate of the cumulative amount at the exposure time ET3 is 0.58 as indicated at the point PT3. The rate of the cumulative amount at the exposure time ET4 is 0.53 as indicated at the point PT4.

In this manner, the longer the exposure time, the lower the rate of the cumulative amount of the inclination angles θz that are 0° or larger and smaller than 17°. In other words, the longer the exposure time, the higher the rate of the cumulative amount of the inclination angles θz that are 17° or larger. As illustrated in FIG. 20, the rates of the cumulative amounts of the inclination angles θz that are 17° or larger at the exposure time ET1, ET2, ET3, and ET4 are within ranges indicated by dotted arrows A1, A2, A3, and A4, respectively.

The rate of the cumulative amount of the inclination angles θz that are 17° or larger indicated by the arrow A1, A2, A3, or A4 is equal to a value obtained by subtracting the rate of the cumulative amount of the inclination angles θz that are 0° or larger and smaller than 17° from 1. Specifically, at the exposure time ET1, the rate of the cumulative amount of the inclination angles θz that are 17° or larger is 0.2 as indicated by the arrow A1. At the exposure time ET2, the rate of the cumulative amount of the inclination angles θz that are 17° or larger is 0.25 as indicated by the arrow A2. At the exposure time ET3, the rate of the cumulative amount of the inclination angles θz that are 17° or larger is 0.42 as indicated by the arrow A3. At the exposure time ET4, the rate of the cumulative amount of the inclination angles θz that are 17° or larger is 0.47 as indicated by the arrow A4.

As illustrated in FIG. 19, in the case of the incident angle Φ0 of 60° and the output angle Φ2 of 40°, the reflectivity can be increased when the exposure time is ET2 or longer. Accordingly, as indicated by a dotted line CL8 in FIG. 20, it is preferable that the rate of the inclination angles θz 17° or larger be 0.25 or higher. In this case, when the incident light 110 enters at the incident angle Φ0 of 60°, the rate of light that is emitted at the output angle Φ2 of 0° and toward the first direction D1 side with respect to the normal line NL, out of the output light 120, can be increased. Consequently, even when the observer 105 looks into the display surface 1a obliquely from above the display device 1, the visibility of the image displayed on the display surface 1a can be improved. Thus, the display device 1 according to the present embodiment exhibits excellent visibility of the image.

Similarly, when the inclination angle θz is θB (29°) at the exposure time ET1 and the exposure time ET2, the rate of the cumulative amount of the inclination angles θz that are 0° or larger and smaller than 29° is 0.95 or higher. That is, the rate of the cumulative amount of the inclination angles θz that are 29° or larger is 0.05 or lower. At the exposure time ET3, the rate of the cumulative amount of the inclination angles θz that are 0° or larger and smaller than 29° is approximately 0.83. That is, the rate of the cumulative amount of the inclination angles θz that are 29° or larger is 0.17 or lower. At the exposure time ET4, the rate of the cumulative amount of the inclination angles θz that are 0° or larger and smaller than 29° is approximately 0.75 as indicated by the point PTS. That is, the rate of the cumulative amount of the inclination angles θz that are 29° or larger is 0.25.

In this manner, the longer the exposure time, the lower the rate of the cumulative amount of the inclination angles θz that are 0° or larger and smaller than 29°. In other words, the longer the exposure time, the higher the rate of the cumulative amount of the inclination angles θz that are 29° or larger. As illustrated in FIG. 20, at the exposure time ET1 and the exposure time ET2, the rate of the cumulative amount of the inclination angles θz that are 29° or larger is 0.05 or lower. At the exposure time ET3, the rate of the cumulative amount of the inclination angles θz that are 29° or larger is 0.17. At the exposure time ET4, the rate of the cumulative amount of the inclination angles θz that are 29° or larger is 0.25 as indicated by the arrow A5.

In the reflective electrode 15 of the present embodiment, it is more preferable that the rate of the cumulative amount of the inclination angles θz that are 29° or larger be 0.25 or higher. Accordingly, when the incident light 110 enters at the incident angle Φ0 of 60°, the rate of light that is emitted toward the first direction D1 side with respect to the normal line NL at the output angle Φ2 of 40°, out of the output light 120, can be increased. Consequently, even when the observer 105 looks into the display surface 1a obliquely from above the display device 1, the visibility of the image displayed on the display surface 1a can be improved.

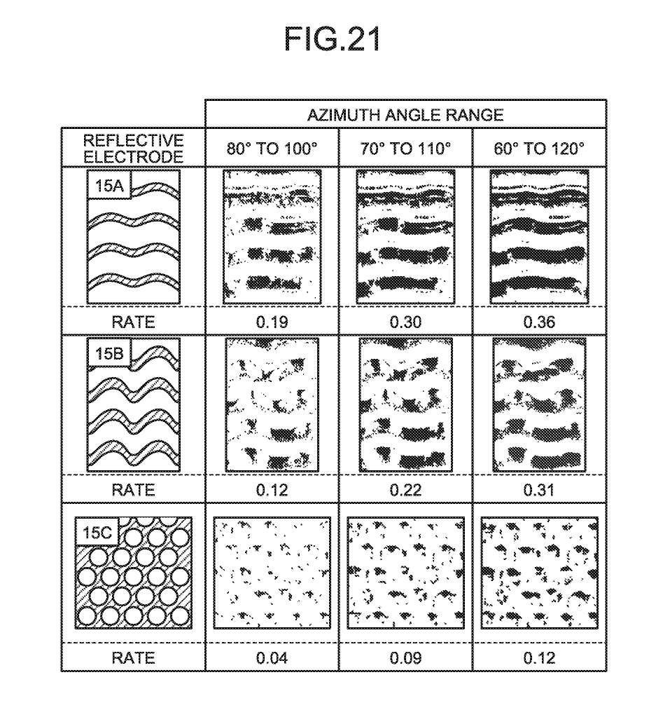

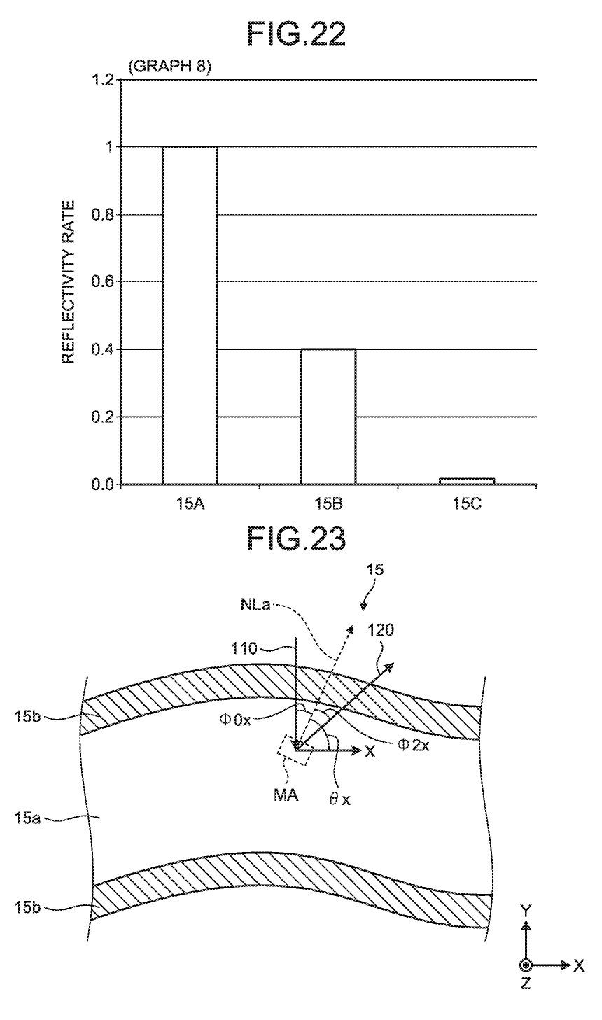

The following describes the distribution of azimuth angles of the reflective electrode 15 with reference to FIGS. 7 and 21 to 23. FIG. 21 is a table illustrating a relation between an azimuth angle range and a rate of an inclination angle. FIG. 22 is a graph illustrating reflectivity rates of light on the reflective electrodes having different azimuth angle ranges. FIG. 23 is a plan view for explaining an azimuth angle of the reflective electrode.

As illustrated in FIG. 7, the raised portion 15a of the reflective electrode 15 has a wave line shape along the X direction in planar view. Thus, a part of the incident light 110 entering from the Y direction is reflected toward the X direction by the reflective electrode 15, and the output light 120 is emitted in a scattered state. This can prevent glare of an image displayed on the display surface 1a.

The “azimuth angle” is, as illustrated in FIG. 23, an inclination angle θx (second inclination angle) formed by the normal line NLa of the micro region MA and the X direction, in planar view. For example, the incident light 110 entering from the Y direction is incident on the micro region MA at an incident angle Φ0x with respect to the normal line NLa. The output light 120 is reflected by the micro region MA, and is emitted toward the opposite side of the incident direction with respect to the normal line NLa at an output angle Φ2x. Similarly to the inclination angle θz (polar angle), a difference in position of the micro region MA changes a value of the inclination angle θx (azimuth angle).

In the present specification, the “rate of the inclination angle θx” indicates, when a certain region of the reflective electrode 15 is divided into a plurality of micro regions MA in planar view, an abundance ratio of the micro regions MA having the inclination angle θx. Specifically, the “rate of the inclination angle θx” is a value obtained by dividing the number of micro regions MA having the inclination angle θx within a certain angle range, by the total number of the micro regions MA.

In a reflective electrode 15A and a reflective electrode 15B illustrated in FIG. 21, the raised portion 15a is provided in a wave line shape, similarly to the above-described reflective electrode 15. In the reflective electrode 15B, the wave of the raised portion 15a has larger amplitude than that in the reflective electrode 15A. A reflective electrode 15C is a reflective electrode of the comparative example, and has a plurality of circular raised portions 15a arrayed therein in planar view.

In the reflective electrodes 15A, 15B, and 15C illustrated in FIG. 21, hatching is given to portions that are lower than a certain height in the direction perpendicular to the surface 11a of the respective first substrates 11. That is, the hatching is not given to the raised portion 15a, and the recessed portion 15b is indicated by hatching. Each of the micro regions MA included in a range of the azimuth angle (inclination angle θx) from 80° to 100°, a range of the azimuth angle from 70° to 110°, and a range of the azimuth angle from 60° to 120° is indicated in black.

As illustrated in FIG. 21, in the reflective electrode 15A, the rate of the inclination angles θx in the azimuth angle range from 80° to 100° is 0.19, the rate of the inclination angles θx in the azimuth angle range from 70° to 110° is 0.30, and the rate of the inclination angles θx in the azimuth angle range from 60° to 120° is 0.36.

In the reflective electrode 15B, the rate of the inclination angles θx in the azimuth angle range from 80° to 100° is 0.12, and the rate of the inclination angles θx in the azimuth angle range from 70° to 110° is 0.22. In the reflective electrode 15B, the rate of the inclination angles θx in the azimuth angle range from 60° to 120° is 0.31.

In the reflective electrode 15C, the rate of the inclination angles θx in the azimuth angle range from 80° to 100° is 0.04, and the rate of the inclination angles θx in the azimuth angle range from 70° to 110° is 0.09. In the reflective electrode 15C, the rate of the inclination angles θx in the azimuth angle range from 60° to 120° is 0.12.

The rate of the inclination angles θx in a certain azimuth angle range decreases in order of the reflective electrodes 15A, 15B, and 15C. That is, in the raised portion 15a, as the amplitude of the wave becomes smaller and the wave becomes closer to a straight line along the X direction, the rate of the inclination angles θx in a certain azimuth angle range increases and the rate of the output light 120 scattered in the X direction decreases. In other words, the rate of the output light 120 scattered in the X direction increases in order of the reflective electrodes 15A, 15B, and 15C, and dependency of the output light 120 on the azimuth angle can be made small.

The graph 8 in FIG. 22 illustrates measured results of reflectivity on the reflective electrodes 15A, 15B, and 15C when the incident light 110 enters at the incident angle Φ0 of 60°, and the output light 120 is emitted at the output angle Φ2 of 40°. FIG. 22 indicates, by assuming the reflectivity of the reflective electrode 15A to be 1, the rates of reflectivity of the reflective electrode 15B and the reflective electrode 15C to the reflectivity of the reflective electrode 15A.

As illustrated in FIG. 22, assuming the reflectivity of the reflective electrode 15A to be 1, the rate of reflectivity of the reflective electrode 15B is approximately 0.4 and that of the reflective electrode 15C is approximately 0.02. In this manner, the rate of reflectivity decreases in order of the reflective electrodes 15A, 15B, and 15C. In other words, the higher the rate of the inclination angles θx in a certain azimuth angle range, the higher the rate of reflectivity tends to become.

When the incident light 110 enters at the incident angle Φ0 of 60°, the reflective electrode 15A can make the light intensity of the output light 120 having the output angle Φ2 of 40° higher than those of the reflective electrodes 15B and 15C. The reflective electrode 15B can make the light intensity of the output light 120 having the output angle Φ2 of 40° higher than that of the reflective electrode 15C of the comparative example, while lowering dependency of the output light 120 on a direction.

Based on the above results, regarding the distribution of the inclination angles θx of the raised portions 15a of the reflective electrode 15, it is preferable that the rate of the inclination angles θx in the azimuth angle range from 60° to 120° be 0.31 or higher. Furthermore, it is more preferable that the rate of the inclination angles θx in the azimuth angle range from 70° to 110° be 0.22 or higher. This can increase the reflectivity of the output light 120 emitted toward the first direction D1 (see FIG. 17) with respect to the normal line NL while lowering dependency of the output light 120 on a direction.

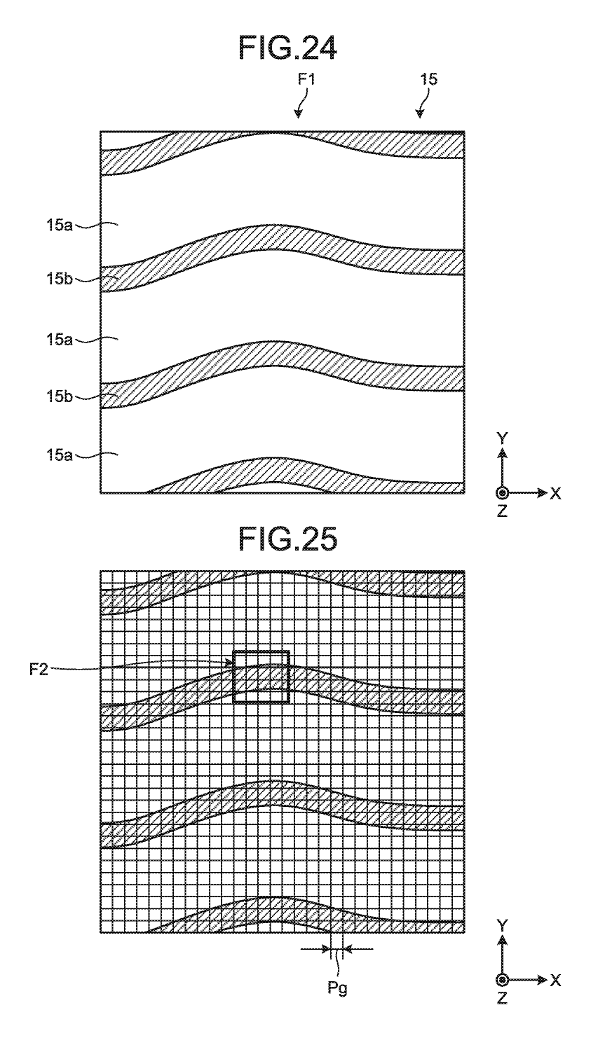

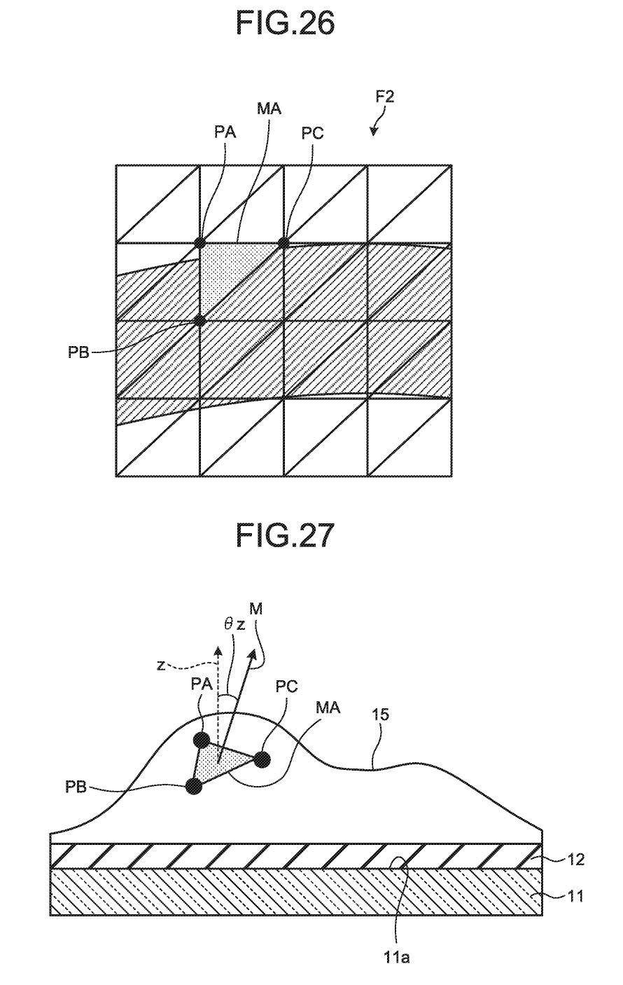

The following describes the method of measuring inclination angle distribution of the reflective electrode 15. FIG. 24 is a schematic diagram illustrating shape data of the reflective electrode for explaining one example of the measurement method of the inclination angle distribution. FIG. 25 is a schematic diagram illustrating a state in which the shape data of the reflective electrode is divided for explaining one example of the measurement method of the inclination angle distribution. FIG. 26 is a plan view for explaining micro regions of the reflective electrode. FIG. 27 is a schematic diagram illustrating a normal vector of a micro region of the reflective electrode.

As illustrated in FIG. 24, the shape data of the raised portions 15a and the recessed portions 15b of the reflective electrode 15 is measured. The shape data to be acquired is from a certain observation region F1 of a plane of one reflective electrode 15. In the example illustrated in FIG. 24, three raised portions 15a are included in the observation region F1. However, the present disclosure is not limited this configuration, and four or more raised portions 15a may be included in the observation region F1, or the shape data of the entire reflective electrode 15 may be acquired. The shape data includes information in the X direction and the Y direction, as well as information in the Z direction. The resolution in the Z direction is 0.01 μm, for example.

The shape data of the reflective electrode 15 can be measured by a laser microscope and a scanning probe microscope (SPM) such as an atomic force microscope (AFM).

Subsequently, as illustrated in FIG. 25, the uneven shape data is divided into a plurality of pieces along the X direction and the Y direction to have a certain division width Pg. The division width Pg is 0.137 μm, for example. FIG. 26 illustrates a region F2 in FIG. 25 in an enlarged manner. As illustrated in FIG. 26, in each divided region, a region that is a plane including three adjacent intersections PA, PB, and PC, and is enclosed by straight lines connecting the intersections PA, PB, and PC is assumed to be the micro region MA. The divided micro region MA has an area of 0.005 μm² to 0.04 μm², for example. The size of the observation region F1 and the division width Pg can be changed as appropriate according to the resolution and the magnification of an imaging camera.

As illustrated in FIG. 27, a normal vector M=(m1, m2, m3) of the micro region MA is calculated. Then, it is assumed that an angle formed by a vector z=(0, 0, 1) in the direction perpendicular to the surface 11a of the first substrate 11 and the normal vector M=(m1, m2, m3) is a polar angle (inclination angle θz).

The inclination angle θz is calculated for all the micro regions MA in the observation region F. The rate of the inclination angles θz is obtained by summing up the number of micro regions MA having the inclination angles θz that fall within a certain angle range, and dividing the number by the total number of the micro regions MA.

Similarly, it is assumed that an angle formed by the normal vector M=(m1, m2, m3) and a vector x=(1, 0, 0) in a direction in parallel with the surface 11a of the first substrate 11 is an azimuth angle (inclination angle θx). The inclination angle θx is calculated for all the micro regions MA in the observation region F. The rate of the inclination angles θx is obtained by summing up the number of micro regions MA having the inclination angles θx that fall within a certain angle range, and dividing the number by the total number of the micro regions MA.

Modification

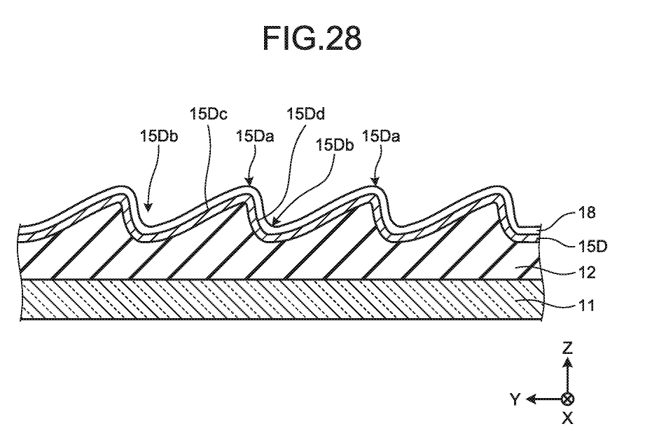

FIG. 28 is a cross-sectional view illustrating a reflective electrode according to a modification of the embodiment. In a reflective electrode 15D illustrated in FIG. 28, a raised portion 15Da and a recessed portion 15Db are repeatedly arrayed along the Y direction. The raised portion 15Da has a first inclined surface 15Dc and a second inclined surface 15Dd. The length of the first inclined surface 15Dc in the Y direction is longer than that of the second inclined surface 15Dd. The first inclined surface 15Dc is provided at a gentle inclination angle with respect to the second inclined surface 15Dd. In this manner, the reflective electrode 15D may have an asymmetric shape such as a saw-tooth shape in cross-sectional view.

In the present modification, the first inclined surface 15Dc includes a portion formed in a straight-line shape in cross-sectional view, which can increase the rate of the inclination angles θz in a certain angle range. Accordingly, the output light 120 can be efficiently emitted toward the first direction D1 (see FIG. 17) with respect to the normal line NL.

Manufacturing Method of Reflective Electrode

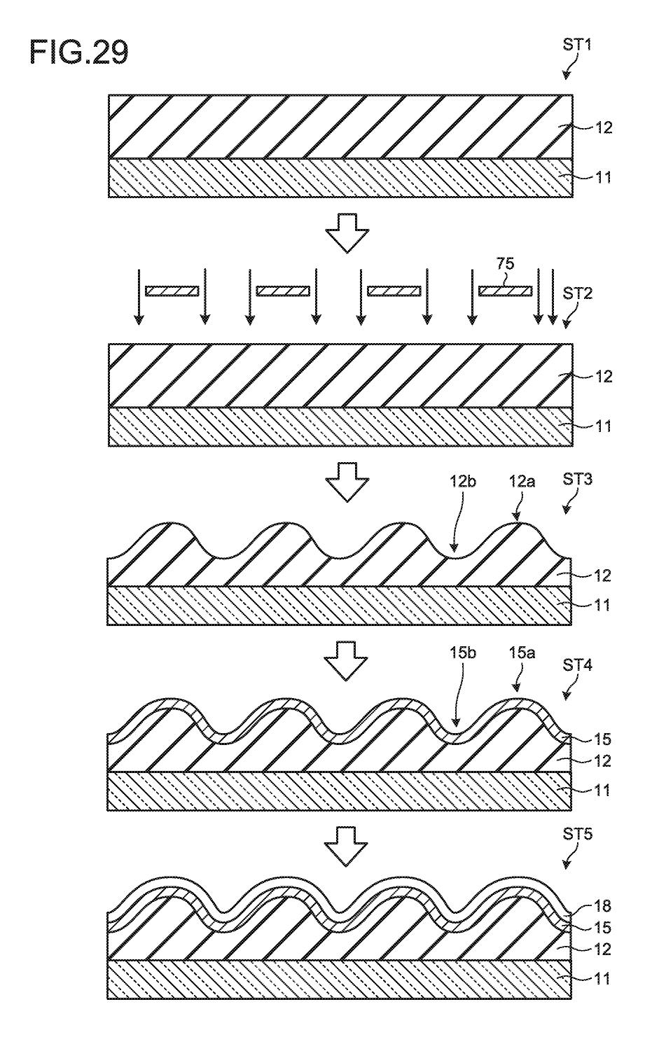

FIG. 29 is a process diagram for explaining one example of a manufacturing method of the reflective electrode according to the embodiment. First, the insulating layer 12 is formed on the first substrate 11 (Step ST1). The film of the insulating layer 12 can be formed by spin coating or the like using photosensitive resin.

A mask 75 having openings in a certain pattern is arranged above the insulating layer 12. Then, light is emitted from a light source, which is not illustrated, to perform exposure (Step ST2). The pattern of the openings of the mask 75 has a shape corresponding to the recessed portions 15b illustrated in FIG. 7, which is a wave line shape in planar view.

Then, development is performed on the insulating layer 12. The exposed portion of the insulating layer 12 is removed to leave the unexposed portion of the insulating layer 12. Then, a heat treatment at a certain temperature and time causes the surface of the insulating layer 12 to have a cross-sectional shape of a smooth curve, a circular arc, or an elliptic arc. This allows the insulting layer 12 to have the raised portion 12a and the recessed portion 12b that are repeatedly arrayed (Step ST3). The insulating layer 12 employs a positive type photosensitive resin to leave the unexposed portion, but may employ a negative type. The exposure time is appropriately set such that the recessed portion 12b of the insulating layer 12 does not reach the first substrate 11.

Subsequently, a metal film is formed on the insulating layer 12 by sputtering or the like using metal materials including aluminum (Al), silver (Ag), and others. This forms the reflective electrodes 15 (Step ST4). The reflective electrodes 15 are formed by following the method of forming the surface shape of the insulating layer 12 to have a shape of a surface in which a plurality of raised portions 15a and recessed portions 15b are arrayed.

Thereafter, the orientation film 18 is applied and formed on the reflective electrodes 15 (Step ST5). The reflective electrodes 15 can be manufactured by the above-mentioned processes.

In the manufacturing method of the reflective electrodes 15 according to the present embodiment, the height of the raised portions 12a of the insulating layer 12 changes according to the exposure time indicated at Step ST2. The longer the exposure time, the greater the height of the raised portions 12a becomes. Because the surface shape of the reflective electrodes 15 is formed by following the surface shape of the insulating layer 12, the height of the raised portions 15a of the reflective electrode 15 is set according to the height of the raised portions 12a of the insulating layer 12. This allows the inclination angle θz of the reflective electrode 15 to be different according to the exposure time, as explained with reference to FIGS. 18 and 19, etc.

Electronic Shelf Label

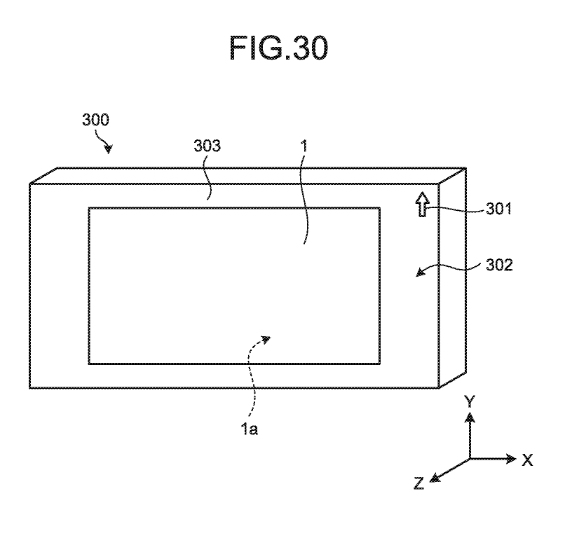

FIG. 30 is a diagram illustrating a configuration example of an electronic shelf label according to the embodiment. As illustrated in FIG. 30, an electronic shelf label 300 includes the display device 1, and a housing 303 that houses the display device 1. The electronic shelf label 300 is, for example, a price tag used for the shelf 102 on which products are put on display, and displays the price and others of a product on the display surface 1a of the display device 1. The electronic shelf label 300 can change the price and others displayed on the display surface 1a by receiving a signal from a controller, which is not illustrated, by radio or the like.

A mark 301 is provided on a front 302 of the housing 303, the mark 301 indicating an incident direction of light which is predetermined when the electronic shelf label 300 is mounted on a store shelf or the like. The incident direction of light is the direction (Y direction) in which the raised portions 15a of the reflective electrode 15 are arrayed as illustrated in FIG. 7 and others.

This allows a worker to correctly mount the electronic shelf label 300 on the shelf 102 or the like such that a positional relation between the electronic shelf label 300 and the lighting fixture 100 mounted on the ceiling becomes appropriate. As a result, the light emitted from the lighting fixture 100 can be made incident on the reflective electrode 15 at the incident angle of 0° to 60°. The output light 120 is emitted toward the incident direction side with respect to the normal line of the display surface 1a at the output angle of 0° to 40°.

Thus, even when the observer 105 looks into the electronic shelf label 300 obliquely from above, the luminance of the display surface 1a seen from the observer 105 can be increased and the observer 105 can easily visually recognize the price and the like being projected on the display surface 1a. Accordingly, the electronic shelf label 300 including the display device 1 exhibits good visibility of the image.

While the preferred embodiment according to the present disclosure has been described, the embodiment is not intended to limit the present disclosure. The contents disclosed in the embodiment are given by way of example only, and various changes may be made without departing from the spirit of the present disclosure. Appropriate changes made without departing from the spirit of the present disclosure naturally fall within the technical scope of the present disclosure. At least one of various omissions, substitutions, and modifications of the constituent elements can be made without departing from the scope of the above-described embodiment and modification.

For example, the configuration, shape, and others of the raised portion 15a of the reflective electrode 15 are merely examples, and may be modified as appropriate. The raised portions 15a may have shapes different from one another, and may have heights h3 or pitches p different from one another. The display device 1 is not limited to the configuration illustrated in FIG. 1 and others. For example, the configuration and arrangement of the common electrode 23, the quarter-wave plate 24, the half-wave plate 25, the polarizing plate 26, and others illustrated in FIG. 1 may be modified as appropriate.

What is claimed is:

1. A display device comprising:
a first substrate;
a second substrate facing the first substrate;
a liquid crystal layer provided between the first substrate and the second substrate; and
a reflective electrode provided between the first substrate and the liquid crystal layer, wherein
the reflective electrode includes a plurality of raised portions that reflect incident light entering from outside,
when the reflective electrode is divided into a plurality of micro regions each having a certain area in planar view, a rate of inclination angles of the raised portions is a value obtained by dividing the number of the micro regions having the inclination angles within a certain angle range, by the total number of the micro regions, and
the inclination angles of the raised portions are distributed such that the rate of the inclination angles of 17° or larger is 0.25 or higher.

2. The display device according to claim 1, wherein, when an angle formed by a normal line of each micro region and a normal line of a display surface is a polar angle, first inclination angles out of the inclination angles each correspond to the polar angle.

3. The display device according to claim 1, wherein the inclination angles are distributed such that the rate of the inclination angles of 29° or larger is 0.25 or higher.

4. The display device according to claim 1, wherein, when an angle formed by a normal line of each micro region and a certain direction in parallel with a display surface is an azimuth angle, second inclination angles out of the inclination angles each correspond to the azimuth angle, and
the second inclination angles are distributed such that the rate of the second inclination angles ranging from 60° to 120° is 0.31 or higher.

5. The display device according to claim 1, wherein, when an angle formed by a normal line of each micro region and a certain direction in parallel with a display surface is an azimuth angle, second inclination angles out of the inclination angles each correspond to the azimuth angle, and
the second inclination angles are distributed such that the rate of the second inclination angles ranging from 70° to 110° is 0.22 or higher.

6. The display device according to claim 1, wherein the raised portions are each provided along a first direction in parallel with a plane of the first substrate, and are arranged in a second direction intersecting with the first direction.

7. The display device according to claim 6, wherein the raised portions each have a wave line shape formed by repeatedly arraying a circular arc or an elliptic arc in planar view in the first direction.

8. The display device according to claim 1, wherein
the incident light enters at an incident angle of 0° to 60° with respect to a normal line of a display surface, and
output light reflected by the reflective electrode is emitted toward an incident direction side with respect to the normal line of the display surface at an output angle of 0° to 40°.

9. An electronic shelf label comprising:
the display device according to claim 1; and
a housing that houses the display device, wherein
the housing is provided with a mark indicating a predetermined incident direction of light.
